(19) United States
(12) Patent Application Publication
(10) Pub. No.: US 2020/0238319 A1
(43) Pub. Date: Jul. 30, 2020

(54) Sprinkler Convenient to Stop Water

(71) Applicant: Cixi Storm Showers Co., Ltd., Ningbo Zhejiang Province (CN)

(72) Inventor: Jinwei ZHANG, Ningbo Zhejiang Province (CN)

(21) Appl. No.: 16/395,270

(22) Filed: Apr. 26, 2019

(30) Foreign Application Priority Data
Jan. 26, 2019 (CN) 201920135198.2
Jan. 26, 2019 (CN) 201920135201.0

(51) Int. Cl. B05B 12/00; B05B 1/30; E03C 1/046

(52) U.S. Cl. CPC B05B 12/002; F16K 3/0254; E03C 1/046; B05B 1/3026

(57) ABSTRACT

Disclosed is a sprinkler convenient to stop water. The sprinkler convenient to stop the water includes a housing and a water stop switch, the water stop switch includes a through hole arranged on the housing in a penetration manner and a water stop rod slidably disposed in the through hole, a water inlet communicating with a water inlet channel and a water outlet communicating with a water outlet channel are respectively formed at two sides of the through hole, a water passing hole is formed on a middle portion of the water stop rod in a penetration manner, and a water stop sealing cap matched with the water outlet is further disposed on the water stop rod and is located at one side, close to the water outlet, of the water stop rod.

### TECHNICAL FIELD

The present disclosure relates to a sprinkler convenient to stop water.

### BACKGROUND

A sprinkler is also referred to as a shower head. It was a device for watering flowers, bonsais and other plants originally and then was modified by a person into a shower device to become a common article in a bathroom. A water saving function is a key point to be considered when the sprinkler is purchased. The sprinkler in the conventional art is not provided with a water stop design and is mainly controlled by a heater valve, so that the waste is caused in a certain degree and the use is very inconvenient; or the existing water stop switch has a complex structure and a poor water stop property; and the sealing property of the water stop switch is poor to cause the water seepage.

### SUMMARY

In order to solve the defects of the conventional art, the present disclosure is intended to provide a sprinkler convenient to stop water, which can conveniently implement a water stop function and has a simple switch structure and a good water stop property.

To this end, the following technical solutions are adopted by the present disclosure: a sprinkler convenient to stop water includes a housing and a water stop switch, the water stop switch includes a through hole arranged on the housing in a penetration manner and a water stop rod slidably disposed in the through hole, a water inlet communicating with a water inlet channel and a water outlet communicating with a water outlet channel are respectively formed at two sides of the through hole, a water passing hole is formed on a middle portion of the water stop rod in a penetration manner, and a water stop sealing cap matched with the water outlet is further disposed on the water stop rod and is located at one side, close to the water outlet, of the water stop rod.

In some embodiments, the water stop switch further includes a spring disposed between the water stop sealing cap and the water stop rod.

In some embodiments, the water stop switch further includes a first seal ring annularly disposed on the water stop rod.

In some embodiments, the water stop switch further includes press caps fixedly disposed at two ends of the water stop rod.

In some embodiments, the press caps are in a sliding fit with the housing.

In some embodiments, a sliding groove is formed on the housing, a skirting edge matched with the sliding groove is disposed on each of the press caps, and the skirting edge is slidably disposed in the sliding groove.

In some embodiments, the housing includes a sprinkling head and a hollow handle, a connection pipe is stretched out downwardly from the sprinkling head, and the water stop switch is disposed on the connection pipe.

In some embodiments, the sprinkling head further includes a discoid sprinkler upper shell, and the sprinkler upper shell and the connection pipe are fixed and integrated together.

In some embodiments, the sprinkling head further includes a water yielding mask detachably connected to the sprinkler upper shell.

In some embodiments, a water flow shift switch is disposed on the water yielding mask.

In some embodiments, the housing includes a sprinkling head and a hollow handle, a separated release pipe is disposed in the handle, an opening for taking and placing the release pipe is formed on the handle, vitamin C granules are accommodated in the release pipe, a release hole is formed at a bottom of the release pipe, and the water can come in and out from the release hole.

In some embodiments, the release hole is of a horn shape having a big top and a small bottom.

In some embodiments, the handle is of a hollow cylindrical structure having a big top and a small bottom, and an outline structure of the release pipe is matched with a shape of an internal cavity of the handle, so that the release pipe only can be accommodated in the handle in an opening inverted manner.

In some embodiments, the release pipe includes a pipe body and a cover disposed at a bottom of the pipe body, and the release hole is formed on the cover.

In some embodiments, a first internal screw thread is disposed at the bottom of the pipe body, and a first external screw thread matched with the first internal screw thread is disposed on the cover.

In some embodiments, a second seal ring is disposed between the pipe body and the cover.

In some embodiments, the opening is formed at a top end of the handle, a second internal screw thread is further disposed on a sidewall of the top end of the handle, the sprinkling head includes a connection pipe stretched out downwardly, and a second external screw thread matched with the second internal screw thread is disposed at a bottom end of the connection pipe.

The present disclosure has the following beneficial effects: the sprinkler can be convenient to implement a water stop function, the switch structure is simple and the water stop property is good.

### BRIEF DESCRIPTION OF THE DRAWINGS

FIG. 1 is a structural schematic diagram of the present disclosure.

FIG. 2 is a sectional view of a sprinkling head of the present disclosure.

FIG. 3 is an enlarged view of a B portion in FIG. 2.

FIG. 4 is a sectional view of a handle of the present disclosure.

FIG. 5 is a sectional view of a release pipe of the present disclosure.

FIG. 6 is an enlarged view of an A portion in FIG. 5.

FIG. 7 depicts a sectional view of a pipe body of the present disclosure.

FIG. 8 depicts a sectional view of a cover of the present disclosure.

### DETAILED DESCRIPTION OF THE EMBODIMENTS

The present disclosure will be described below in detail in combination with the accompanying drawings and specific embodiments.

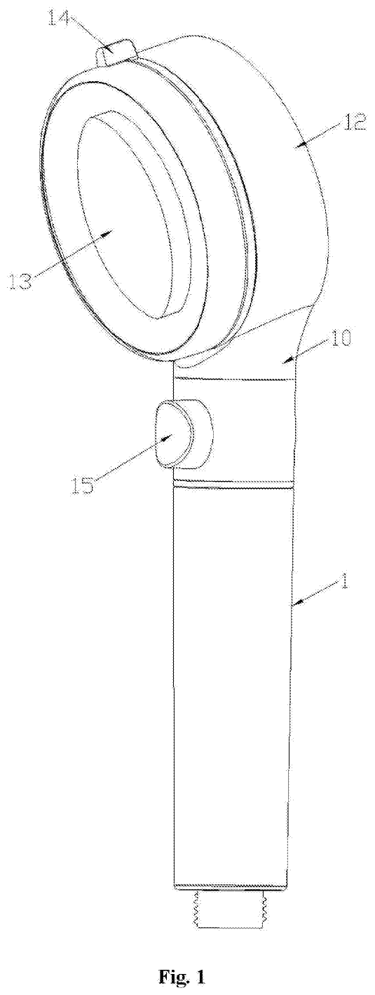

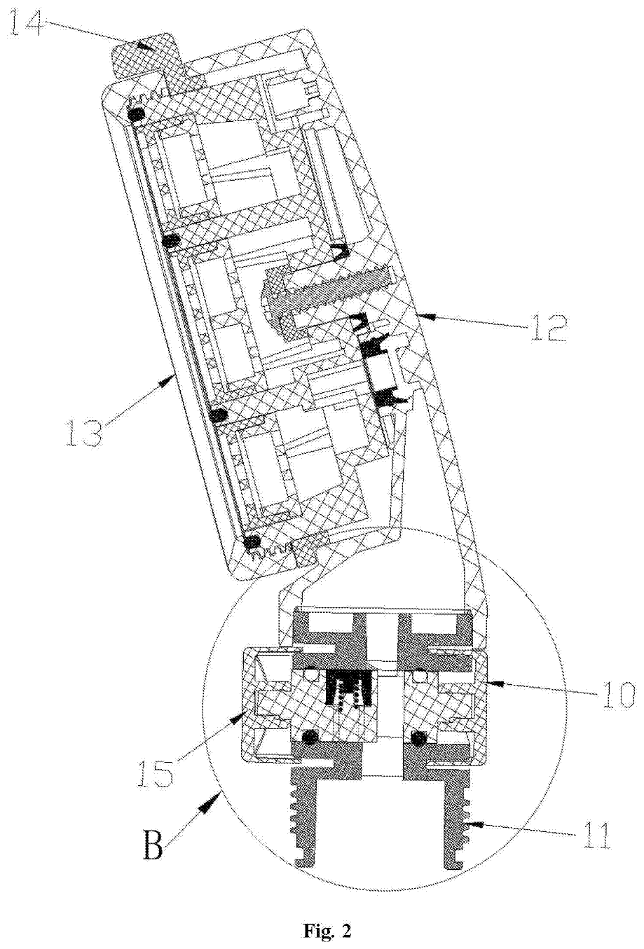

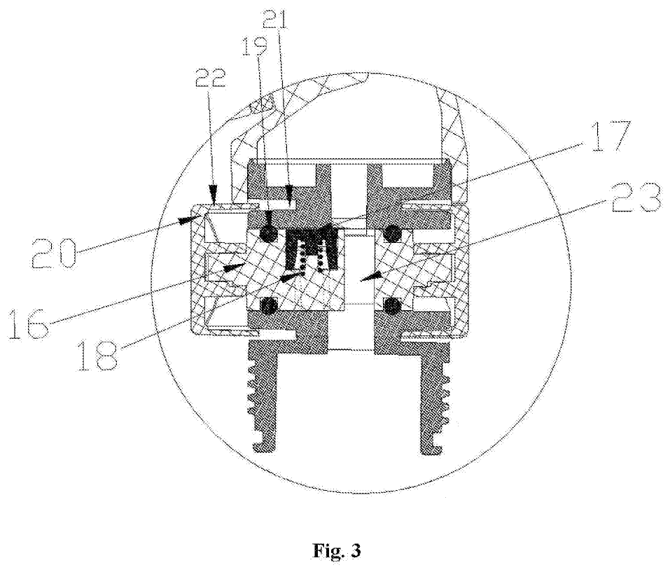

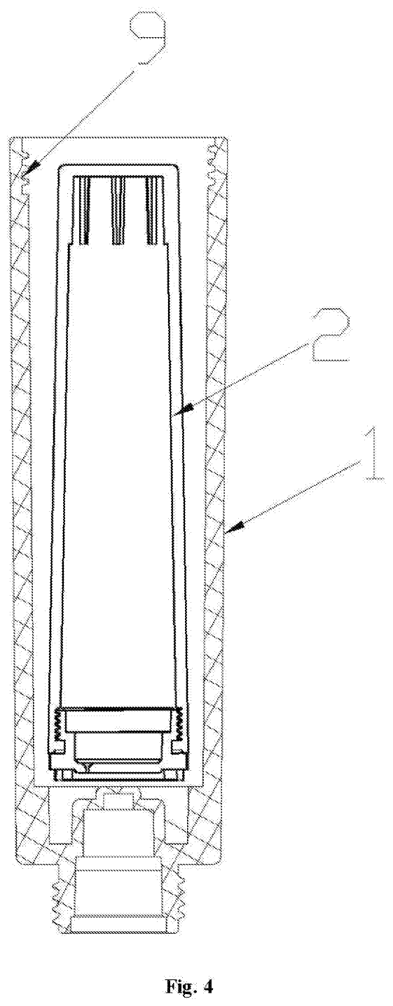

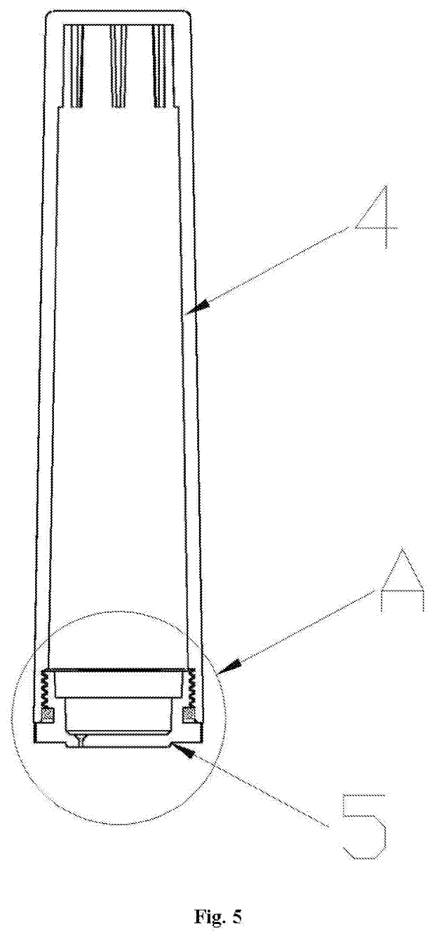

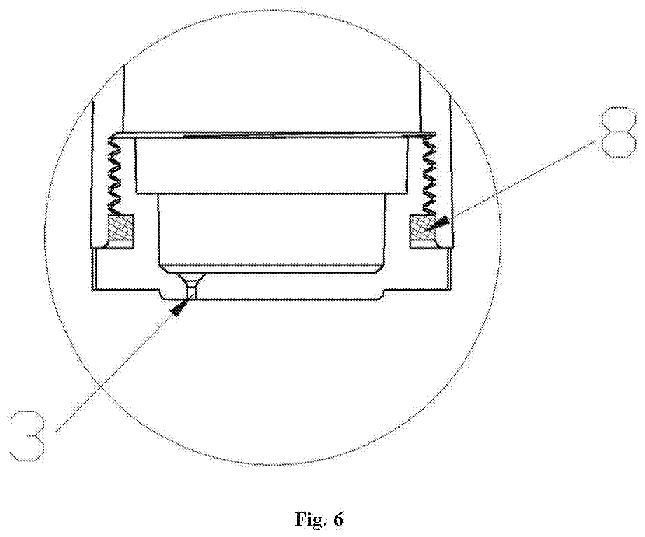

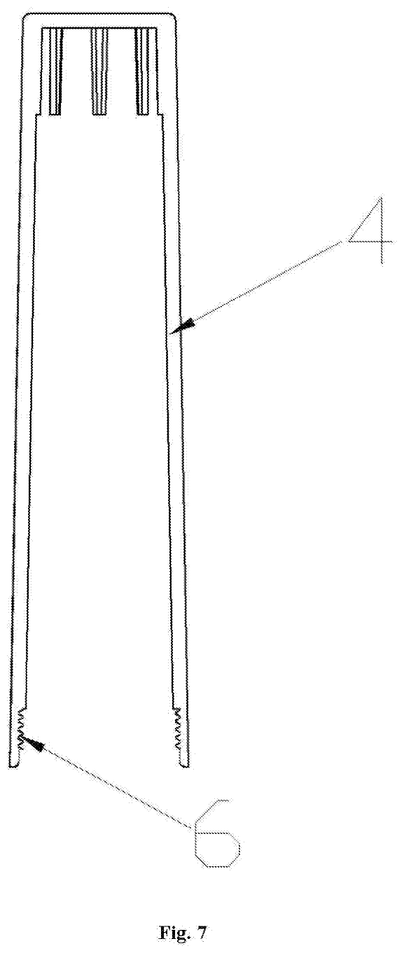

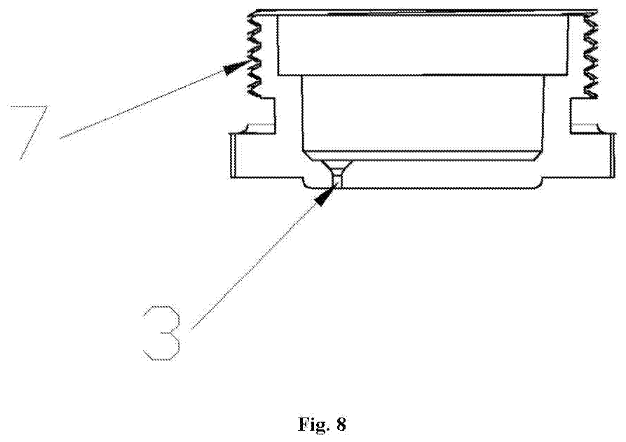

Referring to FIG. 1 to FIG. 8, a sprinkler convenient to stop water includes a housing and a water stop switch 15, the water stop switch includes a through hole arranged on the housing in a penetration manner and a water stop rod 16 slidably disposed in the through hole, a water inlet communicating with a water inlet channel and a water outlet communicating with a water outlet channel are respectively formed at two sides of the through hole, a water passing hole 23 is formed on a middle portion of the water stop rod in a penetration manner, and a water stop sealing cap 17 matched with the water outlet is further disposed on the water stop rod and is located at one side, close to the water outlet, of the water stop rod.

In this embodiment, the water stop switch further includes a spring 18 disposed between the water stop sealing cap and the water stop rod.

In this embodiment, the water stop switch further includes a first seal ring 19 annularly disposed on the water stop rod.

In this embodiment, the water stop switch further includes press caps 20 fixedly disposed at two ends of the water stop rod.

In this embodiment, the press caps are in a sliding fit with the housing.

In this embodiment, a sliding groove 21 is formed on the housing, a skirting edge 22 matched with the sliding groove is disposed on each of the press caps, and the skirting edge is slidably disposed in the sliding groove.

In this embodiment, the housing includes a sprinkling head and a hollow handle 1, a connection pipe 10 is stretched out downwardly from the sprinkling head, and the water stop switch 15 is disposed on the connection pipe.

In this embodiment, the sprinkling head further includes a discoid sprinkler upper shell 12, and the sprinkler upper shell and the connection pipe are fixed and integrated together.

In this embodiment, the sprinkling head further includes a water yielding mask 13 detachably connected to the sprinkler upper shell.

In this embodiment, a water flow shift switch 14 is disposed on the water yielding mask.

In this embodiment, the housing includes a sprinkling head and a hollow handle 1, a separated release pipe 2 is disposed in the handle, an opening for taking and placing the release pipe is formed on the handle, vitamin C granules are accommodated in the release pipe, a release hole 3 is formed at a bottom of the release pipe, and the water can come in and out from the release hole.

In this embodiment, the release hole is of a horn shape having a big top and a small bottom.

In this embodiment, the handle is of a hollow cylindrical structure having a big top and a small bottom, and an outline structure of the release pipe is matched with a shape of an internal cavity of the handle, so that the release pipe only can be accommodated in the handle in an opening inverted manner.

In this embodiment, the release pipe includes a pipe body 4 and a cover 5 disposed at a bottom of the pipe body, and the release hole is formed on the cover.

In this embodiment, a first internal screw thread 6 is disposed at the bottom of the pipe body, and a first external screw thread 7 matched with the first internal screw thread is disposed on the cover.

In this embodiment, a second seal ring 8 is disposed between the pipe body and the cover.

In this embodiment, the opening is formed at a top end of the handle, a second internal screw thread 9 is further disposed on a sidewall of the top end of the handle, the sprinkling head includes a connection pipe 10 stretched out downwardly, and a second external screw thread 11 matched with the second internal screw thread is disposed at a bottom end of the connection pipe.

The above illustrates and describes the basic principles, main features and advantages of the present disclosure. It should be understood by a person skilled in the art that the above embodiments are not intended to limit the present disclosure in any form; and any technical solution obtained by adopting a manner of equivalent replacement or equivalent change is fallen into a protection scope of the present disclosure.

What is claimed is:

1. A sprinkler convenient to stop water, comprising a housing and a water stop switch, wherein the water stop switch comprises a through hole arranged on the housing in a penetration manner and a water stop rod slidably disposed in the through hole, a water inlet communicating with a water inlet channel and a water outlet communicating with a water outlet channel are respectively formed at two sides of the through hole, a water passing hole is formed on a middle portion of the water stop rod in a penetration manner, and a water stop sealing cap matched with the water outlet is further disposed on the water stop rod and is located at one side, close to the water outlet, of the water stop rod.

2. The sprinkler convenient to stop water as claimed in claim 1, wherein the water stop switch further comprises a spring disposed between the water stop sealing cap and the water stop rod.

3. The sprinkler convenient to stop water as claimed in claim 1, wherein the water stop switch further comprises a first seal ring annularly disposed on the water stop rod.

4. The sprinkler convenient to stop water as claimed in claim 1, wherein the water stop switch further comprises press caps fixedly disposed at two ends of the water stop rod.

5. The sprinkler convenient to stop water as claimed in claim 4, wherein the press caps are in a sliding fit with the housing.

6. The sprinkler convenient to stop water as claimed in claim 5, wherein a sliding groove is formed on the housing, a skirting edge matched with the sliding groove is disposed on each of the press caps, and the skirting edge is slidably disposed in the sliding groove.

7. The sprinkler convenient to stop water as claimed in claim 1, wherein the housing comprises a sprinkling head and a hollow handle, a connection pipe is stretched out downwardly from the sprinkling head, and the water stop switch is disposed on the connection pipe.

8. The sprinkler convenient to stop water as claimed in claim 7, wherein the sprinkling head further comprises a discoid sprinkler upper shell, and the sprinkler upper shell and the connection pipe are fixed and integrated together.

9. The sprinkler convenient to stop water as claimed in claim 8, wherein the sprinkling head further comprises a water yielding mask detachably connected to the sprinkler upper shell.

10. The sprinkler convenient to stop water as claimed in claim 9, wherein a water flow shift switch is disposed on the water yielding mask.

11. The sprinkler convenient to stop water as claimed in claim 1, wherein the housing comprises a sprinkling head and a hollow handle, a separated release pipe is disposed in the handle, an opening for taking and placing the release pipe is formed on the handle, vitamin C granules are accommodated in the release pipe, a release hole is formed at a bottom of the release pipe, and the water can come in and out from the release hole.

12. The sprinkler convenient to stop water as claimed in claim 11, wherein the release hole is of a horn shape having a big top and a small bottom.

13. The sprinkler convenient to stop water as claimed in claim 11, wherein the handle is of a hollow cylindrical structure having a big top and a small bottom, and an outline structure of the release pipe is matched with a shape of an internal cavity of the handle, so that the release pipe only can be accommodated in the handle in an opening inverted manner.

14. The sprinkler convenient to stop water as claimed in claim 11, wherein the release pipe comprises a pipe body and a cover disposed at a bottom of the pipe body, and the release hole is formed on the cover.

15. The sprinkler convenient to stop water as claimed in claim 14, wherein a first internal screw thread is disposed at the bottom of the pipe body, and a first external screw thread matched with the first internal screw thread is disposed on the cover.

16. The sprinkler convenient to stop water as claimed in claim 14, wherein a second seal ring is disposed between the pipe body and the cover.

17. The sprinkler convenient to stop water as claimed in claim 11, wherein the opening is formed at a top end of the handle, a second internal screw thread is further disposed on a sidewall of the top end of the handle, the sprinkling head comprises a connection pipe stretched out downwardly, and a second external screw thread matched with the second internal screw thread is disposed at a bottom end of the connection pipe.
